(19) United States
(12) Patent Application Publication
(10) Pub. No.: US 2022/0325869 A1
(43) Pub. Date: Oct. 13, 2022

(54) A LUMINAIRE USING A LIGHT MIXING CHAMBER

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL); JOHANNES PETRUS MARIA ANSEMS, HULSEL (NL)

(21) Appl. No.: 17/641,046

(22) PCT Filed: Sep. 8, 2020
(86) PCT No.: PCT/EP2020/075046

§ 371 Date: Mar. 7, 2022

(30) Foreign Application Priority Data
Sep. 12, 2019 (EP) 19197097.9

(51) Int. Cl. F21V 7/00; F21V 13/02; F21K 9/62

(52) U.S. Cl. CPC F21V 7/0016; F21V 13/02; F21K 9/62; F21Y 2115/10

(57) ABSTRACT

A luminaire (10) has first light source (30) which provides light into a light mixing chamber (20) such that un-collimated light reaches the light output face (26) of the light mixing chamber (20), and a second light source (32) which provides collimated light to the light output face (26). The luminaire (10) can thus produce a diffuse flat light output and/or a directed partially collimated light output for example for task lighting.

### FIELD OF THE INVENTION

This invention relates to luminaires which use a light mixing chamber.

### BACKGROUND OF THE INVENTION

Light mixing chambers are used in luminaires to provide a diffused light output and thereby generate light that is not harsh and direct but instead is a flat and even light. The diffusion function also hides the light sources from the view of the user and hence provides a desired uniform appearance of a luminaire using the light mixing chamber.

However, for certain applications such as for task lighting or in certain conditions collimated light is desired. A light mixing chamber is generally not able to create such task light as a result of the deliberate diffusion created by the light mixing chamber.

It would therefore be desirable to be able to switch between diffuse light and direct e.g. collimated light. One option is to use a switchable diffuser. However, this adds cost and complexity to a luminaire. An alternative solution is therefore desired.

### SUMMARY OF THE INVENTION

The invention is defined by the claims.

According to examples in accordance with an aspect of the invention, there is provided a luminaire, comprising:

a housing comprising a base, a side wall and a top cover which defines a light exit surface, wherein a light mixing chamber is formed between the base, top cover and side wall, and wherein the top cover comprises a diffuser;

a first light source for providing light into the light mixing chamber such that a majority of the light output from the first light source reaches the top cover as un-collimated light; and

a second light source for providing collimated light to the top cover.

The un-collimated light delivered to the top cover by the first light source functions to provide a diffuse light output. Diffuse, un-collimated light generally is used as uniform, ambient light. The collimated light delivered to the top cover by the second light source functions to provide a direct narrow beam light output. The narrow beam, collimated light generally is used as spotlight or as task light. The characteristics of the diffuser are selected such that the effect (i.e. beam widening) on the collimated light from the second light source is sufficiently small that a more direct light output results than from the first light source. However, the second light source remains hidden from view by the diffuser, when the second light source is not turned on.

By un-collimated for example is meant that the light has a FWHM of more than 25 degrees, for example more than 40 degrees, such as 60 degrees. Thus, the light is not confined to a narrow range of directions. Usually, a greater FWHM of un-collimated light corresponds to more homogeneous (ambient) lighting. The un-collimated light output is typically the native light output of the light source, such as an LED chip. By collimated light is meant that the light has a FWHM of less than 25 degrees, for example less than 20 degrees, such as 10 degrees. Usually, a smaller FWHM of collimated light corresponds to improved spot lighting or task lighting. This is achieved typically by adding a collimation function downstream of the light output from the native light source.

At least 70%, such as at least 80%, such as at least 90% of the light output from the first light source reaches the top cover as un-collimated light. Usually, a greater proportion corresponds to more homogeneous (ambient) lighting. The first light source may for example generate only un-collimated light, for example with a Lambertian light output distribution.

At least 80% of the light output from the second light source may directly impinge on the top cover as collimated light, such as at least 85%, such as least 90%, such as at least 95% such as at least 97%. Usually, a greater proportion corresponds to improved spot lighting or task lighting.

The diffuser for example has a reflectance in the range from 10 to 20%, such as 12 to 18%, such as 13 to 17%, such as 14 to 16%. This reflectance (and hence corresponding transmittance) enables the desired light mixing function and masking of the second light source to achieved while preventing the second light source being visible. On the one hand the reflectivity of the diffuser should not be too high as then too much reflections leading to undesired (extra) light losses and undesired scattering/diffusing of collimated light from the second light source occurs, while on the other hand the reflectivity of the diffuser should not be too low as then the desired masking of the second light source in the off-state is not obtained and/or the desired light mixing function is insufficient. The ranges for reflectance given above reflect the delicate balance between these inversely related phenomena (of undesired scattering/diffusing and sufficient masking).

In one example, the first light source is mounted on the side wall. In this way, most of the light output is initially laterally directed, and hence not towards the top cover, and only reaches the top cover after one or more reflections within the mixing chamber, thereby providing a diffuse output.

In another example, the first light source is mounted on the top cover facing the base, and a reflector is provided in the path of light from the first light source. In this way, all of the light output is initially directed away from the top cover, and only reaches the top cover after at least a reflection from the reflector and typically also one or more reflections within the light mixing chamber, thereby providing a diffuse output.

The reflector is for example curved and directs light from the first light source to an area of the base. In this way, there is at least a reflection from the reflector and a reflection from the base before the light reaches the top cover.

In another example, the first light source is mounted on the base. In this way the light output is directed to the top cover. The light output is then designed to be sufficiently diffuse that additional reflections are not essential.

One way to avoid the need for additional reflections in this way is to provide a sufficient distance between the first light source and the top cover. For example, a distance between the base and the top cover may be larger than 20 mm, such as larger than 30 mm, such as larger than 40 mm, such as larger than 50 mm. The distance is for example 150 mm or less, to enable integration into a ceiling cavity, for example. When the second light source is mounted on the base either directly or indirectly (for example mounted via a carrier), said distance between base and top cover is about the same as the distance between the second light source and the top cover, which renders that the discernibility of the second light source through the diffusing cover is further reduced, i.e. with increasing distance the discernibility of the second light source becomes less and the uniformity of the light exit surface improves.

Another way to avoid the need for additional reflections is to provide a refractive light spreader over the first light source.

The second light source for example has a collimated light output with a full width at half maximum (in respect of the light intensity versus light exit angle), FWHM, of less than 25 degrees, such as less than 20 degrees, such as less than 10 degrees, such as less than 6 degrees. This provides a light output which, even after passage through the diffuser, is suitable as direct light, such as task light.

The second light source for example comprises (or is coupled with) a total internal reflection collimator or a reflector collimator.

The base and side wall for example have a reflective inner surface. It may be at least partially light scattering (i.e. functioning as a diffuser) such that reflections provide beam spreading of the light.

The first and second light sources are preferably independently controllable, so that the luminaire can be driven between direct e.g. task light and diffuse light, or the combination of both.

A controller is for example provided for independently controlling the first and second light sources in response to an input command.

The first light source may comprise a first array of first light source elements and/or the second light source may comprise a second array of second light source elements. Thus, the total light output may be selected by using multiple light sources.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows an array of panels forming a ceiling, wherein one panel comprises a luminaire;

FIG. 2 shows a first example of the design of the luminaire in cross section;

FIG. 3 shows a second example of the design of the luminaire in cross section;

FIG. 4 shows a third example of the design of the luminaire in cross section; and

FIG. 5 shows the beam width for the light output generated by the second light sources downstream of the diffusing top cover as a function of the beam spot width.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a luminaire in which a first light source provides light into a light mixing chamber such that un-collimated light reaches the light output face, and a second light source provides collimated light to the light output face. The luminaire can thus produce a diffuse flat light output and/or a directed partially collimated light output for example for task lighting.

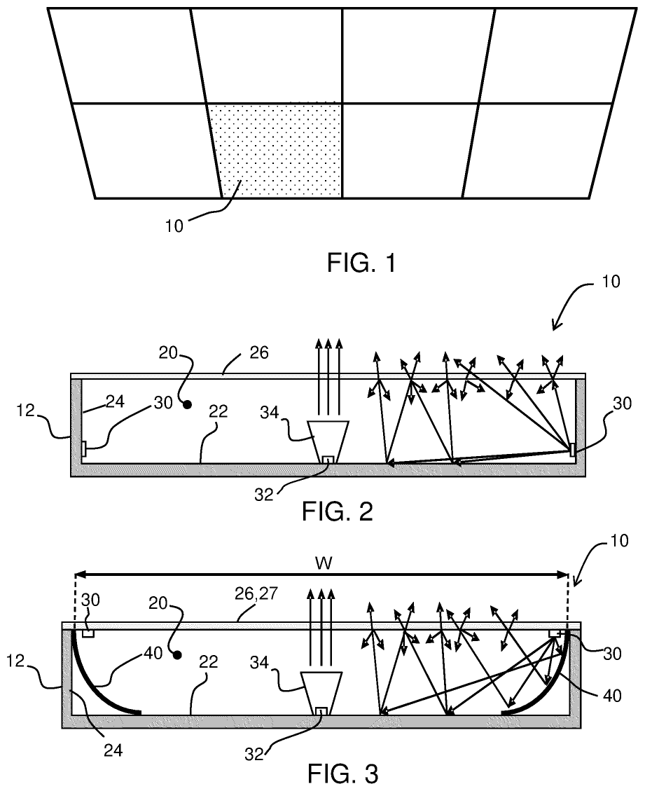

FIG. 1 shows an array of panels forming a ceiling, wherein one panel 10 comprises a luminaire. The panel 10 comprises a light mixing chamber, which houses a light source arrangement. The light source arrangement is switchable between a diffuse un-collimated light output and a directional light output.

FIG. 2 shows a first example of the design of the luminaire 10 in cross section.

The luminaire 10 comprises a housing 12 which defines a light mixing chamber 20 between a base 22, a side wall 24 and a top cover 26. The top cover 26 forms a light exit surface of the luminaire. The top cover 26 comprises a diffuser.

In plan view, the luminaire may be rectangular or square, so there is a set of four side wall portions forming the side wall. However, it may be any shape and may include a single side wall in a curved shape.

The luminaire may be for suspension from a ceiling or from a rail arrangement rather than for integration into the structure of the ceiling, and hence may have any shape. For a ceiling panel, there may be a standardized size for the luminaire, such as 600 mm×600 mm, 1200 mm×1200 mm, 600 mm×1200 mm or 1200 mm v 1200 m. However, the luminaire may generally have any size and shape.

A first light source 30 is for providing light into the light mixing chamber 20 such that un-collimated light reaches the top cover 26.

In particular, at least 51% of the light output from the first light source reaches the top cover as un-collimated light (i.e. the majority), such as at least 70%, such as at least 80%, such as at least 90% The first light source for example provides only un-collimated light. The output light distribution is for example Lambertian.

A greater proportion corresponds to more homogeneous lighting.

A second light source 32 is for providing collimated light to the top cover. The second light source 32 is mounted on the base 22 and faces the top cover 26 and delivers a collimated light output. For example, at least 80% of the light output from the second light source directly impinges on the top cover as collimated light, such as at least 85%, such as least 90%, such as at least 95% such as at least 97%.

A greater proportion corresponds to improved spot lighting.

This is for example achieved by a collimator 34 over an LED light source (which generates a native Gaussian light distribution). The collimation function may instead be integrated into the design of the light source itself. The collimator may be based on reflection or total internal reflection.

The side wall and the base for example have a reflectivity of at least 85%, more preferably at least 90%, most preferably at least 92% such as for example 95% or 97%. A higher reflectivity is desired to improve light mixing of the light output from the first light source in the light mixing chamber. Furthermore, it improves the efficiency.

The side wall and base may for example comprise a reflective coating or layer. The reflective layer may be based on silver and/or aluminum. The coating may for example be based on reflective particles in a matrix material. The matrix material may be a polymer such as for example of silicone, PE, PC or PMMA. Suitable particles are flakes or glitter such as particles made from BaSO4, Al2O3 and/or TiO2.

The reflectivity may be specular, but is more preferably diffusive. A diffuse reflector improves light mixing in the mixing box and improve the homogenous light emission at the top cover.

The un-collimated light delivered to the top cover 26 by the first light source 30 functions to provide a diffuse light output. The collimated light delivered to the top cover by the second light source 32 functions to provide a more directional narrow beam light output. The characteristics of the diffuser of the top cover 26 are selected such that the effect (i.e. beam widening) on the collimated light from the second light source 32 is sufficiently small that a more direct light output results than from the first light source, and this more direct light output is suitable for example for task lighting.

However, the second light source remains hidden from view by the diffuser when not turned on.

The diffuser of the top cover 26 for example has a reflectance in the range from 10 to 20%, such as 12 to 18%, such as 13 to 17%, such as 14 to 16%. This reflectance (and hence corresponding transmittance) enables the desired light mixing function and masking of the second light source to achieved while preventing the second light source being visible.

The reflectance of the diffuser controls the amount of light mixing.

The light that passes through the diffuser is subject to scattering resulting in some beam spreading, in particular so that the appearance of the second light source is at least partially hidden when the second light source is turned off.

The diffuser formed by the top cover is preferably flat, and can have any shape in plan view, such as round, square, rectangular, oval, pentagonal or hexagonal. The top cover for example has a thickness in the range from 2 mm to 20 mm, more preferably 3 to 10 mm, most preferably 4 to 7 mm.

The diffuser may be made from a polymer, ceramic or glass. It may include scattering particles such as BaSO4, TiO2, A12O3, and/or silicone particles.

In the example of FIG. 2, the first light source 30 is mounted on the side wall. In particular, in the example shown, there is a set of light sources on a pair of opposing side wall portions. Light sources may be provided all around the side wall, i.e. on all four side wall portions for a square or rectangular design. However there may be any number of first light sources 30. In this way, most of the light output is initially laterally directed parallel to (rather than towards) the top cover, and only reaches the top cover after one or more reflections within the mixing chamber (for example from the base as shown), thereby providing a diffuse output.

In another example shown in FIG. 3, the second light source 32 is mounted on the base 22 and the first light source 30 faces the base 22 and is mounted on the top cover 26 within the light exit surface 27 that extends over the full distance W between reflectors 40, which are provided in the path of light from the first light source 30. The reflector may have the design and properties as discussed above for the reflection provided by the side wall and base. There may for example be a set of first light sources around a perimeter of the luminaire. In this way, all of the light output is initially directed away from the top cover 26, and only reaches the top cover to generate the output after at least a reflection from the reflector 40 and typically also one or more reflection within the mixing chamber (in particular from the base, as shown), thereby providing a diffuse light output.

The reflector 40 is for example curved and thus directs light from the first light source to an area of the base. In this way, there is at least a reflection from the reflector and a reflection from the base before the light reaches the top cover.

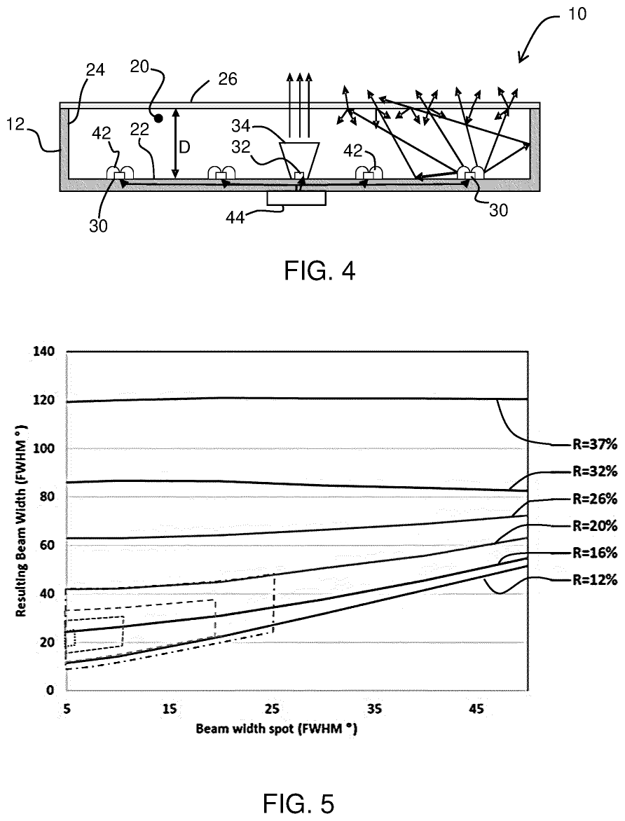

In another example shown in FIG. 4, both the first light source 30 and the second light source 32 are mounted on the base. The difference between the light output from the two light sources is then the result of the different native light source outputs. In particular, the first light source has a wide beam output whereas the second light source has a collimated output, as discussed above. There is preferably an array of first light sources on the base. The light outputs from the first light sources overlap before they reach the top cover 26, and in combination with the effect of the diffuser, the result is a sufficiently uniform light output.

To provide the desired uniform light output for the first light sources, a large distance is provided between the first light sources and the top cover. For example, a distance D between the base and the top cover may be larger than 20 mm such as larger than 30 mm, such as larger than 40 mm, such as larger than 50 mm. The distance is for example 150 mm or less, to enable integration into a ceiling cavity, for example.

The spacing between the first light sources 30 is for example equal to or less than the spacing between the base and top cover.

FIG. 4 shows the additional (or alternative) measure of adding a refractive light spreader 42 over each of the first light sources.

In all examples above, the second light source for example has a collimated light output with a full width at half maximum, FWHM, of less than 25 degrees, such as less than 20 degrees, such as less than 10 degrees, such as less than 6 degrees. This provides a light output which, even after passage through the diffuser, is suitable as direct light, such as task light.

A smaller FWHM corresponds to provided spot lighting.

FIG. 4 also shows a controller 44 to enable independent control of the first and second light sources, so that the luminaire can be driven between direct e.g. task light and diffuse light or a combination of both. The controller may receive user commands by a wired or wireless connection or by direct user input (e.g. for a luminaire within reach of the user, such as a desk luminaire). The luminaire may also include sensors for automatically controlling the light output, for example to provide task light in response to presence detection in a workspace beneath the luminaire, and to provide general light in response to presence detection elsewhere.

FIG. 5 shows the beam width for the light output generated by the second light source downstream of the diffusing top cover (y-axis, FWHM) as a function of the native beam spot width of the second light source (x-axis, FWHM), for a set of six different diffusers, with different amounts of reflectance R (also referred to as backscattering), ranging from 12% to 37%.

The native beam spot width is preferably below 25 degrees and the backscattering is preferably below 20% for example to generate an output beam with a FWHM beam width of below 40 degrees, more preferably below 30 degrees, and even more preferably below 25 degrees.

This shows that a desired task light can be generated based on the combination of a diffuser and a collimated light source (the second light source), but the diffusing top cover still enables the light sources to be substantially hidden from view when they are turned off.

As explained above various design features are used to provide optimum homogeneous lighting, spot lighting and efficiency. The options described may be combined in any way. By way of example, the following options may be combined:

at least 90% of the light output from the first light source reaches the top cover as un-collimated light;

at least 95% of the light output from the second light source directly impinges on the top cover as collimated light;

the collimated light output of the second light source has a FWHM less than 6 degrees; and

the base and side wall have a reflectivity of at least 90%.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims.

The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. Any reference signs in the claims should not be construed as limiting the scope.

1. A luminaire configured to produce diffuse light and/or partially collimated light, the luminaire comprising:
a housing comprising a base, a side wall and a top cover which defines a light exit surface, wherein a light mixing chamber is formed between the base, top cover and side wall, and wherein the top cover comprises a diffuser;
a first light source for providing light into the light mixing chamber such that a majority of the light output from the first light source reaches the top cover as un-collimated light; and
a second light source for providing collimated light to the top cover,
a controller for independently controlling the first and second light sources in response to an input command,
wherein the diffuser has a reflectance in the range from 10 to 16%, and
wherein the second light source has a collimated light output with a full width at half maximum, FWHM, of less than 6 degrees.

2. A luminaire as claimed in claim 1, wherein at least 70%, such as at least 80%, such as at least 90% of the light output from the first light source reaches the top cover as un-collimated light.

3. A luminaire as claimed in claim 1, wherein at least 80% of the light output from the second light source directly impinges on the top cover as collimated light, such as at least 85%, such as least 90%, such as at least 95% such as at least 97%.

4. A luminaire as claimed in any claim 1, wherein the diffuser has a reflectance in the range from 12 to 16%.

5. A luminaire as claimed in claim 1, wherein the first light source is mounted on the side wall.

6. A luminaire as claimed in claim 1, wherein the first light source is mounted on the top cover facing the base, and a reflector is provided in the path of light from the first light source.

7. A luminaire as claimed in claim 6, wherein the reflector is curved and directs light from the first light source to an area of the base.

8. A luminaire as claimed in claim 1, wherein the first light source is mounted on the base.

9. A luminaire as claimed in claim 8, wherein a distance D between the base and the top cover is larger than 20 mm, such as larger than 30 mm, such as larger than 40 mm, such as larger than 50 mm.

10. A luminaire as claimed in claim 8, further comprising a refractive light spreader provided over the first light source.

11. (canceled)

12. A luminaire as claimed in claim 1, wherein the second light source comprises or is coupled to a total internal reflection collimator or a reflector collimator.

13. A luminaire as claimed in claim 1, wherein the second light source is mounted on the base.

14. A luminaire as claimed in claim 1, wherein the first light source comprises a first array of first light source elements and/or the second light source comprises a second array of second light source elements.

15. (canceled)
